(19) United States
(12) Patent Application Publication
(10) Pub. No.: US 2003/0106543 A1
(43) Pub. Date: Jun. 12, 2003

(54) Crankcase ventilation system for an internal-combustion engine with exhaust gas turbocharging and method of using same

(76) Inventors: Werner Gschwindt, Sternenfels (DE); Albrecht Reustle, Walheim (DE); Thomas Wasserbaech, Keltern (DE); Thorsten Wunsch, Wimsheim (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/289,445

(22) Filed: Nov. 7, 2002

(30) Foreign Application Priority Data
Nov. 7, 2001 (DE) P 101 54 666.1

(51) Int. Cl. F02B 25/06

(52) U.S. Cl. 123/572

(57) ABSTRACT

A crankcase ventilation system for an internal-combustion engine with exhaust gas turbocharging, has a first vent pipe which is connected on one side with the crankcase space and on the other side with an intake pipe of the internal-combustion engine. Viewed in the flow direction, the first vent pipe leads in behind a throttle valve arranged in the intake pipe. A second vent pipe is connected on one side with the crankcase space and on the other side with the suction side of a compressor. In the first vent pipe, a return valve is arranged which, in a supercharging pressure operation of the internal-combustion engine, prevents that the excess pressure existing in the intake pipe spreads over into the crankcase space. A return valve is arranged in the second vent pipe and the vacuum level for both vent pipes can be adjusted by way of a common pressure regulator. As a result, it is ensured in the case of the crankcase ventilation system in the supercharging pressure operation as well as in the intake operation of the internal-combustion engine that the vacuum in the crankcase space can be adjusted and in the intake operation of the internal-combustion engine, no bypass air arrives behind the throttle valve by way of the suction side of the compressor.

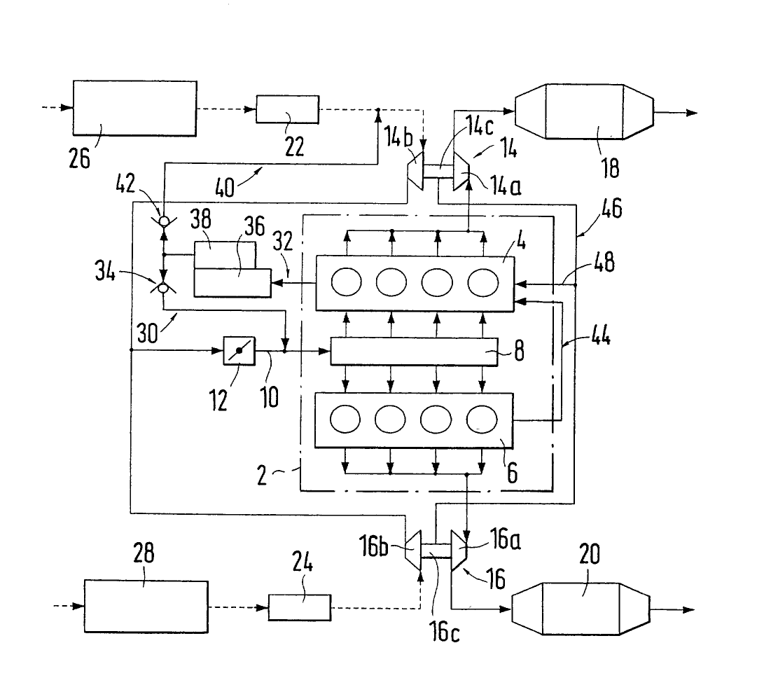

### BACKGROUND AND SUMMARY OF THE INVENTION

This application claims the priority of German Application No. P 101 54 666.1 filed Nov. 7, 2001, the disclosure of which is expressly incorporated by reference herein.

The invention relates to a crankcase ventilation system for an internal-combustion engine with exhaust gas turbocharging. Preferred embodiments relate to a crankcase ventilation system for an internal-combustion engine with exhaust gas turbocharging comprising a first vent pipe which is connected on one side with a crankcase space and on an other side with an intake pipe of the internal-combustion engine, the first vent pipe leading in behind a throttle valve arranged in the intake pipe as viewed in the flow direction, a second vent pipe which is connected on one side with the crankcase space and on an other side with a suction side of an exhaust gas turbocharger, and a return valve arranged in the first vent pipe which in a supercharging pressure operation, prevents that excess pressure existing in the intake pipe spreads over into the crankcase space.

From German Patent Document DE 199 29 876 A1 (corresponding U.S. Pat. No. 6,394,078), a crankcase ventilation system for an internal-combustion engine with exhaust gas turbocharging is known in which two crankcase ventilation paths are provided. In the partial-load operation or intake operation of the internal-combustion engine, it is ensured by way of a first vent pipe extending from the crankcase space to intake pipe of the internal-combustion engine that the so-called blow-by gases formed during the combustion are returned from the crankcase space to the intake system of the internal-combustion engine. When the exhaust gas turbocharger is active or when the internal-combustion engine is in the supercharging pressure operation, it is also ensured by way of a second vent pipe, which is connected to the suction side of the compressor, that the blow-by gases by way of the compressor in the closed loop are returned to the combustion. Furthermore, the vent pipes are equipped with throttles by way of which a defined vacuum level is adjusted.

With respect to the above, it is an object of the invention to improve a crankcase ventilation system for an internal-combustion engine with exhaust gas turbocharging such that, on the one hand, the required vacuum level in the vent pipes is better adjustable and that it is prevented that, in the intake operation of the internal-combustion engine, bypass air is guided behind the throttle valve arranged in the intake pipe by way of a vent pipe leading to the suction side of the compressor. This would result in problems with respect to the tuning of the idling control since this bypass air is not taken into account in the case of the position of the throttle valve.

According to the invention, this object is achieved by providing a crankcase ventilation system for an internal-combustion engine with exhaust gas turbocharging comprising a first vent pipe which is connected on one side with a crankcase space and on an other side with an intake pipe of the internal-combustion engine, the first vent pipe leading in behind a throttle valve arranged in the intake pipe as viewed in the flow direction, a second vent pipe which is connected on one side with the crankcase space and on an other side with a suction side of an exhaust gas turbocharger, a return valve arranged in the first vent pipe which in a supercharging pressure operation, prevents that excess pressure existing in the intake pipe spreads over into the crankcase space, a return valve arranged in the second vent pipe, and a common pressure regulator for adjusting the vacuum level for both vent pipes.

The throttles which are provided according to the state of the art in the crankcase vent pipes of a supercharged internal-combustion engine are replaced by a common pressure regulator provided for both vent pipes. This creates the possibility of arranging a return valve in the second vent pipe, which is provided for the supercharging pressure operation, which return valve prevents that, in the intake operation of the internal-combustion engine, by way of the second vent pipe, a partial air quantity flowing in behind the throttle valve reaches combustion.

Furthermore, the suggested crankcase ventilation system according to the invention ensures that, in the event of an icing of the vent pipe leading to the intake pipe, which would cause a build-up of excess pressure in the crank space because of non-existing ventilation, the excess pressure can drop by way of the return valve arranged in the second vent pipe (safety function).

Additional characteristics further developing the invention are described below and in the claims.

The common pressure regulator provided for the two vent pipes is advantageously arranged in a common vent pipe section provided for both vent pipes.

So that the oil-containing constituents of the blow-by gases discharged from the crankcase space can be separated before, by way of the intake system of the internal-combustion engine, they are again fed to the combustion, an oil separator is provided in the vent pipe section in certain preferred embodiments of the invention.

Other objects, advantages and novel features of the present invention will become apparent from the following detailed description of the invention when considered in conjunction with the accompanying drawings.

### BRIEF DESCRIPTION OF THE DRAWING

The single drawing FIGURE schematically shows the principle of the crankcase ventilation for a supercharged internal-combustion engine constructed according to preferred embodiments of the invention.

### DETAILED DESCRIPTION OF THE DRAWING

Reference number 2 schematically illustrates the engine block of a V8 biturbo-engine. The engine block 2 has two cylinder bank rows, of which schematically only the cylinder head covers 4 and 6 are shown which close off the engine block. Both cylinder bank rows are supplied with combustion air by way of a common intake system 8. An intake pipe 10 (shown only schematically as an arrow) is connected in front of the intake system 8 in which intake pipe 10, a throttle valve 12 is arranged, in a known manner, which is provided for regulating the combustion air quantity. The internal-combustion engine is equipped with two exhaust gas turbochargers or compressors 14 and 16 which are driven by the exhaust gas flow generated by the combustion and thus supply combustion air compressed in the supercharging pressure operation t6 the intake system. In this case, the two exhaust gas turbochargers 14 and 16 essentially consist of a turbine wheel 14a, 16a and a compressor wheel 14b, 16b which are connected with one another by means of a shaft 14c, 16c. Two catalysts 18 and 20 are connected on the exhaust gas side behind the two exhaust gas turbochargers 14 and 16, while, on the intake side, one air flow meter 22 and 24 respectively as well as one air filter 26 and 28 respectively are connected in front of the exhaust gas turbochargers 14 and 16.

For the ventilation of the blow-by gases generated during the combustion or during the compression in the crankcase space, a first vent pipe 30 is provided which, on one side, by way of a vent pipe section 32, is connected with the cylinder head cover 4 and, by means of its other end, leads into the intake pipe 10 of the internal-combustion engine between the throttle valve 12 and the intake system 8. The cylinder head cover 4, 6 closing off the cylinder head space is connected by way of ventilation paths, which are not shown, with the crankcase space of the internal-combustion engine. In the first vent pipe 30, a return valve 34 is arranged whose function will be described later. In the vent pipe section 32, an oil separator 36 and a pressure regulator 38 are arranged whose methods of operation will also be explained later.

A second vent pipe 40 is provided which, on one side, is connected on the intake side of the compressor wheel 14b and, on the other side, is connected by way of the vent pipe section 32 also by way of the cylinder head cover 4 with the crankcase space of the cylinder bank row. Furthermore, a second return valve 42 is arranged in the second vent pipe 40. In addition, a connection pipe 44 is provided between the two cylinder head covers 4 and 6, by means of which connection pipe 44, the blow-by gases are transferred from the cylinder head cover 6 into the cylinder head cover 4.

In the case of the crankcase ventilation system for an internal-combustion engine with exhaust gas turbocharging, a differentiation is made between two operating conditions of the internal-combustion engine. In the partial-load range, in which the exhaust gas turbocharger 14, 16 is not yet active, the engine is in the conventional intake operation, while the engine is in the supercharging pressure operation when the exhaust gas turbochargers 14, 16 are activated by the exhaust gas mass flow.

In the following, the crankcase ventilation will be described in detail as a function of these two operating conditions of the internal-combustion engine.

When the internal-combustion engine is not yet in the supercharging pressure operation, the crankcase ventilation takes place by way of the first vent pipe 30 because the vacuum existing in the intake pipe 10 is sufficient in order to supply the blow-by gases from the crankcase spaces of the two cylinder bank rows by way of the cylinder head covers 4 and 6, the vent pipe section 32, the oil separator 36 and the pressure regulator 38 again to the intake system 8. By mean of the oil separator 36, the oil-containing constituents of the blow-by gases can be separated, while the pressure regulator 38 ensures that vacuum values which are constant and possibly reduced with respect to the vacuum values in the intake pipe 10 exist in the crankcase space of the two cylinder bank rows. The return valve 42 provided in the second vent pipe 40 ensures that, in this operating condition, no bypass air reaches the intake pipe 10 or the intake system of the internal-combustion engine by way of the second vent pipe 40.

When the internal-combustion engine is in the supercharging pressure operation, the second vent pipe 40 is activated and the vacuum forming on the suction side of the compressor wheel 14b is utilized for returning the blow-by gases forming during the combustion by means of the vent pipe 40 to the suction side of the compressor wheel 14b. In turn, the oil separator 36 arranged in the vent pipe section 32 provides that the oil-containing constituents of the blow-by gases are separated, while the pressure regulator 38 sets a uniform constant vacuum value in the two crankcase spaces. As a result of the return valve 34 provided in the first vent pipe 30, it is ensured that the excess pressure existing in the intake pipe 10 or in the intake system 8 cannot spread to the crankcase spaces.

The two shafts 14c and 16c of the exhaust gas turbochargers 14 and 16 are supplied with lubricating oil by way of so-called catch tanks (which are not shown). For the ventilation of these catch tanks provided on the exhaust gas turbochargers, a third vent pipe 46 is provided which, on one side is connected with the two catch tanks and, on the other side, is connected by way of a connection pipe 48 to the cylinder head cover 4.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. Crankcase ventilation system for an internal-combustion engine with exhaust gas turbocharging comprising:
a first vent pipe which is connected on one side with a crankcase space and on an other side with an intake pipe of the internal-combustion engine, the first vent pipe leading in behind a throttle valve arranged in the intake pipe as viewed in the flow direction,
a second vent pipe which is connected on one side with the crankcase space and on an other side with a suction side of an exhaust gas turbocharger,
a return valve arranged in the first vent pipe which, in a supercharging pressure operation, prevents that excess pressure existing in the intake pipe spreads over into the crankcase space,
a return valve arranged in the second vent pipe, and
a common pressure regulator for adjusting the vacuum level for both vent pipes.

2. Crankcase ventilation system according to claim 1, wherein the pressure regulator is arranged in a vent pipe section provided for both vent pipes.

3. Crankcase ventilation system according to claim 2, wherein an oil separator is provided in the vent pipe section, which oil separator is connected in front of the pressure regulator.

4. An engine assembly with exhaust gas turbocharging including:
a crankcase space,
an intake pipe,
a throttle valve in the intake pipe,
an exhaust gas driven turborcharger, and
a crankcase ventilation system comprising:
a first vent pipe connecting the crankcase space with the intake pipe behind the throttle valve,
a second vent pipe connecting the crankcase space with a suction side of the turbocharger,
a first return valve arranged in the first vent pipe and operable to prevent excess pressure in the intake pipe spreading to the crankcase space during engine supercharging operations,
a second return valve arranged in the second vent pipe, and
a common regulator for adjusting the vacuum level for both vent pipes.

5. An engine assembly according to claim 4, wherein the pressure regulator is arranged in a vent pipe section provided for both vent pipes.

6. An engine assembly according to claim 5, wherein an oil separator is provided in the vent pipe section, which oil separator is connected in front of the pressure regulator.

7. A method of operating the engine assembly of claim 4, including using the common regulator to regulate the first and second return valves.

8. A method of operating the engine assembly of claim 4, comprising:
operating the engine without supercharging by the turbocharger with ventilation of the crankcase by the first vent pipe.

9. A method according to claim 4, comprising:
operating the engine with supercharging by the turbocharger with ventilation of the crankcase utilizing the second vent pipe and vacuum on the suction side of a compressor wheel of the turbocharger for returning flow of gases formed during combustion.
